(19) United States
(12) Patent Application Publication
(10) Pub. No.: US 2024/0321294 A1
(43) Pub. Date: Sep. 26, 2024

(54) Composite Permanent Magnet

(71) Applicant: Kaizhong Gao, North Oaks, MN (US)

(72) Inventor: Kaizhong Gao, North Oaks, MN (US)

(21) Appl. No.: 18/124,564

(22) Filed: Mar. 21, 2023

(51) Int. Cl. G11B 5/127; H01F 13/00; H02K 1/02; H02K 41/035

(52) U.S. Cl. CPC G11B 5/1274; H01F 13/003; H02K 1/02; H02K 41/0354

(57) ABSTRACT

This invention presents a new integrated composite permanent magnet (CPM) structure with precise control over component dimensions and magnetic properties, along with an efficient and cost-effective method for achieving this configuration. The composite magnet provides a stronger magnetic field than traditional magnets, making it suitable for motor and generator applications that require high performance. Specifically, for voice coil motors (VCMs), the composite magnet structure enhances VCM efficiency while consuming the same or fewer rare earth materials. One embodiment of the composite magnet includes a cladding magnet between two core magnets, with opposing magnetization directions, while the cladding magnet's magnetization is perpendicular to the core magnet's magnetization. The difference in thickness between the core and cladding magnets is within 5 micrometers or less, or <1% of the magnet's thickness. The invention also discloses novel manufacturing processes for achieving highly efficient composite magnets with high accuracy control of magnet dimensions. One embodiment involves a reorientation and stacking process added to the conventional NdFeB process after pressing under static field. Another embodiment involves a cutting, reorientation, stacking, and gluing process after annealing. Additionally, the invention presents a two-step magnetizing process before completing the CPM manufacturing process.

### CROSS-REFERENCE TO RELATED APPLICATIONS

Not Applicable

### FIELD OF THE INVENTION

The present disclosure relates to a single-piece Composite Permanent Magnet (CPM) design and a method for producing the CPM with a high degree of accuracy. One preferred embodiment is suitable for hard disk drive (HDD) applications.

### BACKGROUND OF THE INVENTION

Permanent Magnets (PMs) are magnetic materials such as neodymium-iron-boron (NdFeB), samarium-cobalt (SmCo), or ferrite that create persistent magnetic fields. NdFeB magnets have a stronger magnetic field, as measured by maximum energy product (BH)max, compared to SmCo and ferrite magnets. However, increasing their magnetic strength beyond a certain point becomes difficult, and NdFeB magnets are relatively expensive due to the scarcity of rare earth materials.

The magnetic field from a magnet is strongest at its surface and decreases with distance, reducing its strength away from the surface. Magnetic properties such as magnetic anisotropy, magnetic moment, and magnetic flux density may decline as the operating temperature increases. There are different grades of NdFeB, SmCo, and ferrite magnets, with higher grades indicating stronger magnets but also higher costs due to the need for more highly oriented and aligned crystal anisotropies during the manufacturing process. In electromagnetic induction devices such as motors, the torque generated is proportional to the rate of change of magnetic flux density produced by a permanent magnet. As the magnetic flux density increases, the efficiency of the motor improves.

In hard disk drives, PMs are used to rotate magnetic disks and the head stack assembly that hosts the magnetic recording heads, allowing for read and write operations. A higher magnetic field provided by the PMs improves efficiency for random access operations or reduces power consumption. However, optimizing a PM for an application with space constraints using a manufacturable process is challenging, as is the case with hard disk drive applications. Therefore, all HDD voice coil motor (VCM) magnets have a similar structure, either two PMs with opposite magnetization directions or one PM with two approximately equal halves with opposite magnetization directions, to provide the necessary magnetic field for VCM operation. However, the current PM solution is unable to provide additional torque or power density for high-performance applications.

### SUMMARY OF THE INVENTION

The presently disclosed embodiments address many of the issues described above and provide a solution to the disadvantages of conventional PMs by increasing the magnetic flux density output, thereby improving the efficiency of motors and generators that use magnets. These magnets are suitable for various applications, particularly in Voice Coil Motors (VCMs) used in hard disk drives (HDDs) and PM generators (PMGs).

In one embodiment of the invention, a CPM consists of two core magnet regions and a cladding magnet region between them. The magnetization directions in the core magnet regions are substantially opposite to each other, while the magnetization direction of the cladding magnet region is substantially perpendicular to the magnetization direction of the core magnet regions. The thickness difference between the core magnet regions and the cladding magnet region is 5 micrometers (μm) or less.

In another embodiment, a CPM has a core magnet region and a smaller cladding magnet region, where the magnetization directions of both regions are substantially perpendicular to each other. The difference in thickness between the cladding magnet region and the core magnet regions is 5 micrometers or less.

The method for fabricating a CPM involves stacking and reorienting PM blocks before the isostatic pressing step and utilizing a two-step magnetizing process. The first step aligns the magnetization direction of the cladding magnet region, while the second step aligns the magnetization direction of the core magnet regions.

Another method of fabricating the CPM involves cutting, reorienting, stacking, and gluing PM blocks after the sintering and annealing process steps. This is followed by the step further cutting, machining, and grinding. The final step involves a two-step magnetizing process where the first step aligns the cladding region's magnetization direction and the second step aligns the magnetization direction of the core regions.

The CPM of the invention is made from a magnet material with a maximum energy product (BH)max of greater than 10 MGOe in either the core or cladding region. This material may include Neodymium-Iron-Boron (NdFeB) with different levels of rare earth element doping, Samarium Cobalt (SmCo), ferrites such as Barium-Iron-Oxygen, Barium-Nickel-Iron-Oxygen, and Barium-Strontium-Nickel-Iron-Oxygen, Alnico such as Aluminum-Nickel-Cobalt, Aluminum-Nickel-Cobalt-Iron, and Aluminum-Nickel-Cobalt-Iron-Copper, rare earth-transition metal-based materials X—Y, X—Z, or X—Y—Z (where X includes rare earth elements such as Neodymium, Samarium, Gadolinium, Neodymium-Dysprosium, and Neodymium-Dysprosium-Terbium-Gadolinium; Y includes transition metal elements such as Iron, Cobalt, Manganese, and Nickel; and Z includes non-metal elements such as Boron, Silicon, Carbon, Nitrogen, Aluminum, Copper, Silver, Zirconium, etc.), Mn-based permanent magnetic materials X—Y or X—Y—Z, transition metal-platinum-based magnetic materials X—Y, or Iron-Nitride (Fe—N). The composition of these materials can vary, such as NdFeB having different levels of Neodymium concentration or doping with rare earth elements or alloys, such as CeAl, Dysprosium, Terbium, and Praseodymium, with up to 30% of Praseodymium replacing Neodymium in some cases. The CPM material may be any of the above-mentioned magnetic materials.

### BRIEF DESCRIPTION OF THE DRAWINGS

The detailed description and accompanying drawings and tables will provide a better understanding of the invention's various aspects and advantages. The drawings are a part of this specification and include examples of the invention's embodiments, which can take different forms. It's important to note that the drawings may show various aspects of the invention exaggerated or enlarged to aid in understanding. The size of the drawings may not be to scale. Additionally, in the depicted embodiments, like reference numerals in the drawings refer to the conceptual design or structural elements representing each specific component or element of the apparatus.

FIG. 1 shows the standard manufacturing processes for a typical Neodymium-based PM, such as NdFeB.

FIG. 2 illustrates the magnetic field applied to the NdFeB block during the magnetizing step to produce a PM block.

FIG. 3 displays the magnetic field distribution from the magnetizing device used to set the magnetization of the type of PM used in VCM applications.

FIG. 4 depicts a CPM as described in one embodiment of the invention.

FIG. 5 shows the manufacturing processes for NdFeB-based CPMs as described in an embodiment of the invention.

FIG. 6 demonstrates the manufacturing processes for NdFeB-based CPMs as described in another embodiment of the invention.

FIG. 7 illustrates the reorientation and stacking process used as an additional step in the new manufacturing process for CPMs as described in an embodiment of the invention.

FIG. 8 depicts the magnetic field distribution in the second magnetizing step and its impact on the CPM used for VCM applications as described in one embodiment of the invention.

FIG. 9 illustrates a CPM as described in another embodiment of the invention.

FIG. 10 shows a CPM as described in another embodiment of the invention.

FIG. 11 depicts a CPM as described in another embodiment of the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE INVENTION

In the following description, numerous specific details are disclosed to provide a thorough understanding of embodiments of the method, system and apparatus. One skilled in the relevant art will recognize, however, that embodiments of the method, system and apparatus described herein may be practiced without one or more of the specific details, or with other electronic devices, methods, components, and materials, and that various changes and modifications can be made while remaining within the scope of the appended claims. In other instances, well-known electronic devices, components, structures, materials, operations, methods, process steps and the like may not be shown or described in detail to avoid obscuring aspects of the embodiments. Embodiments of the apparatus, method and system are described herein with reference to figures.

Reference throughout this specification to “one embodiment,” “an embodiment,” or similar language means that a particular feature, structure, electronic device, method or characteristic described in connection with the embodiment is included in at least one embodiment. Thus, appearances of the phrases “in one embodiment,” “in an embodiment,” and similar language throughout this specification may refer to separate embodiments or may all refer to the same embodiment. Furthermore, the described features, structures, methods, electronic devices, or characteristics may be combined in any suitable manner in one or more embodiments.

Reference throughout this specification to “the magnetization direction” of the PM or magnet means the PM or magnet's magnetization direction in the absence of the external magnetic field after the magnet being magnetized.

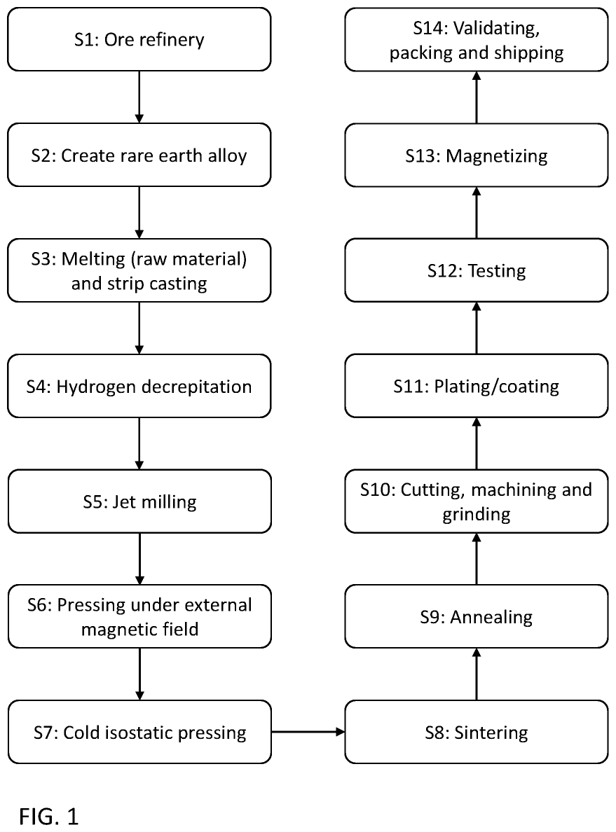

FIG. 1 illustrates the standard manufacture processes for typical Neodymium based PMs, such as NdFeB. The Manufacturing Process Steps of Neodymium magnets, such as NdFeB, are shown as an example. The Process Steps (S) includes: S1: Ore refinery; S2: Create rare earth alloy; S3: Melting and strip casting; S4: Hydrogen Decrepitation; S5: Jet Milling; S6: Pressing under external magnetic field; S7: Cold isostatic pressing; S8: Sintering; S9: Annealing; S10: Cutting, machining and grinding; S11: Plating/coating; S12: Testing; S13: Magnetizing; and finally S14: Validating, packing and shipping. There are many major production steps, plus numerous sub steps, in the manufacture of high-quality PMs. Each step is highly important, and each step is an essential part of a highly refined operation. By Step S9, the PM block is produced, by step S10, the PM block is cut and polished to the desired size and shape, and by step S11, and the PM block is coated. Step S12 completes the test of the materials, and step S13 is to set the magnetization of the PM block for the target application.

Step 1: Ore Refinery—The process of refining rare earth ore involves several steps that depend on the quality of the ore. First, the ore is crushed and milled, followed by a flotation process where the rare earth elements are separated from the tailings using water and special reagents. In some cases, electrolytic refining may also be used. The concentrate produced is then smelted at high temperatures (˜1,500° C.) to separate the valuable metals from the unusable materials in the ore. Extracting rare-earth elements is a challenging task due to their similar properties, and the refinement process requires the use of expensive chemicals and time-consuming procedures. For instance, only 20-30% of the neodymium in neodymium magnets is actually praseodymium, and the alloy used to make magnets is referred to as PrNd because these two elements are chemically similar, difficult to separate, and only have a small impact on the quality of the magnet.

Step S2: Create Rare Earth Alloy-Small additions of other metals are made to NdFeB alloy to refine and modify the micro structure of the final product, enhancing its magnetic properties and enhancing the effects of other processes during the alloying process.

Step S3: Melting and Strip Casting—The alloyed NdFeB is now ready for melting and strip casting. It is heated in a vacuum furnace, and a stream of molten metal is forced under pressure onto a cooled drum, where it rapidly cools. The cooling rate can be approximately 100,000 degrees-per-second. This step produces very small grains of metal that simplify and enhance the downstream processing.

Step S4: Hydrogen Decrepitation—The grains are very small from strip casting. The material from strip casting comes out of the caster in sheets that must be reduced to powder. Hydrogen is purposely introduced to make the material disintegrate. Then it is easy to grind it even smaller in a subsequent operation. Hydrogen Decrepitation is a process used in the production of Neodymium magnets to create extremely small grains.

Step S5: Jet Milling—The Jet Mill uses a high-speed stream of cyclonic inert gas to grind pieces of NdFeB metal into powder. The metal impinges on other pieces of metal powder inside the cyclone. The cyclone automatically classifies the particles by size as they go through the system, maintaining a narrow and favorable particle size distribution. The jet mill grinds NdFeB metal down to fine powder.

Step S6: Pressing under External Magnetic Field—The powder of the NdFeB alloy is kept in an inert gas atmosphere and handled in glove boxes to avoid contamination. The powder is then placed into a mold and subjected to pressure while under a strong magnetic field. This process forms a solid block of material. The magnetic field orients the grains so that the magnetic domains and magnetic anisotropy of the powder are aligned in the desired direction for subsequent processing. The magnetic field can be oriented in two ways: 1) in alignment with the block or 2) perpendicular to the block. Sintered Neodymium magnets are typically pressed perpendicular to the block to achieve the highest anisotropy, resulting in the strongest north-south magnetization. This step results in the formation of an individual magnet block with a preferred anisotropy direction.

Step S7: Cold Isostatic Pressing-After step S6, the magnet block is bagged and submerged into a cold isostatic press (CIP) under great pressure. This removes any remaining air gaps in the block, which comes out of this press considerably smaller than it was when it went in. By this step, the magnet block reduces its size, removes air gaps, and improves its mechanical properties.

Step S8 Sintering: The pressed block is removed from the bag and sintered. Sintering is a process where the blocks are placed in a furnace at a very high temperature just below the melting point of the metal. At this temperature of >1000° C., the individual atoms have a lot of motion, which allows the blocks to develop their full magnetic and mechanical properties. The magnetic domains maintain the same orientation they had before sintering. At this temperature, full density is achieved and the blocks have shrunk to their final size. Note: in this step, the individual atoms have a lot of motion, but the individual grain or powder does not have a large physical motion.

Step S9 Annealing: After the sintering, the blocks are ramped up to a high holding temperature for a set time and then they are ramped down to a lower holding temperature. This step reduces the stresses in the materials. Once the holding time is achieved, the stress-free blocks are slowly cooled to room temperature.

Step S10 Cutting, machining and grinding: Cutting, machining and grinding are performed according to a strict control plan, and waste is minimized by design. Wire cutting is performed with very fine wire to minimize kerf losses. Machining and grinding are minimized by close controls throughout the previous processes. Waste material is reused and recycled. By this step, the magnet is achieved with the desired size and shape.

Step S11 Plating/coating: Most magnets need additional surface treatment to prevent corrosion. The typical surface treatment includes: nickel-copper-nickel electroplate or Aluminum-Zinc, which protects the magnet from corrosion in most typical use environments. This step detail varies depending on customer and application requirements. Different materials may be utilized, such as: Aluminum-Zinc, IVD aluminum or Epoxy. Note, the plating and coating materials used in this step are typically non-magnetic or with a soft magnetic property.

Step S12 Testing: Testing and evaluation are performed on magnet material at almost every process step. By this stage, the testing validates the target size and shape are met. Often, an additional test or measurement is conducted after the magnetizing step to validate the magnet performance.

Step S13 Magnetizing: One of the last steps is magnetizing. The material has not been magnetized yet. The magnet needs to be placed in a strong magnetic field. There are several ways to achieve that. One of the most effective methods is to use an Ampere field from a short electric current pulse, typically less than 1 second. The material is placed inside an electric coil which is energized to produce a very strong magnetic field for a short time. After the coil is de-energized, the magnetic field in the magnet remains.

Step S14 Validating, packing and shipping: After the material is magnetized, a quick testing to validate its performance metric, then the magnet is ready for packaging and shipping. For high performance permanent magnets, strong magnetic force between individual magnets exist when placed next to each other. Extremely care to handle magnets is taken to avoid accidental damage.

Following these steps, high grade (or high energy density) individual NdFeB PM blocks can be produced to the desired size and shape. However, when PM blocks are utilized in different applications, such as for generators, EV motors, Voice coil motors (VCM) and actuators, different applications have different sets of requirements. The magnetic field from each PM block may be reduced which results in a performance degradation.

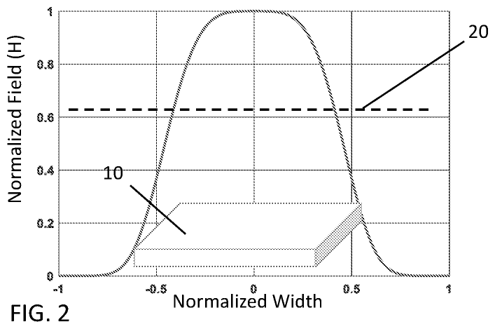

FIG. 2 illustrates the magnetic field distribution at step S13 (magnetizing step) for the fabrication of Neodymium based permanent magnets. An external applied field H is applied to the magnet block 10. The external applied field H can be generated from an external PM structure, an electromagnet structure, or from a custom designed magnetizing device or using two or more of the above-mentioned methods simultaneously. The custom designed magnetizing device typically utilizes a pulsed Ampere field. The device includes a power source and a custom-designed circuit in close proximity to the slot that holds the magnet 10. During operation, a large but short current pulse, typically much less than one second, is shunted. The large current creates a high magnetic field. Typically, a magnetic field higher than 3× of the magnet's coercivity Hc, which is needed to fully saturate the magnet, is required. This field requirement is labeled as Hs, or the saturation field, as illustrated by the dashed line 20. When the external field exceeds this value in the entire region of the magnet 10, it is fully saturated and the magnetization remains after this step is completed. When the external applied field is less than Hs, the magnet is not fully saturated. In the region not completely saturated, the magnetization is reduced when the external magnetic field is removed. Depending on the permanent magnet's initial magnetization state, the Hs may be a different value. Note that for high-grade NdFeB or SmCo based permanent magnets, the anisotropy direction is highly aligned, and the applied field is substantially along the anisotropy easy axis direction.

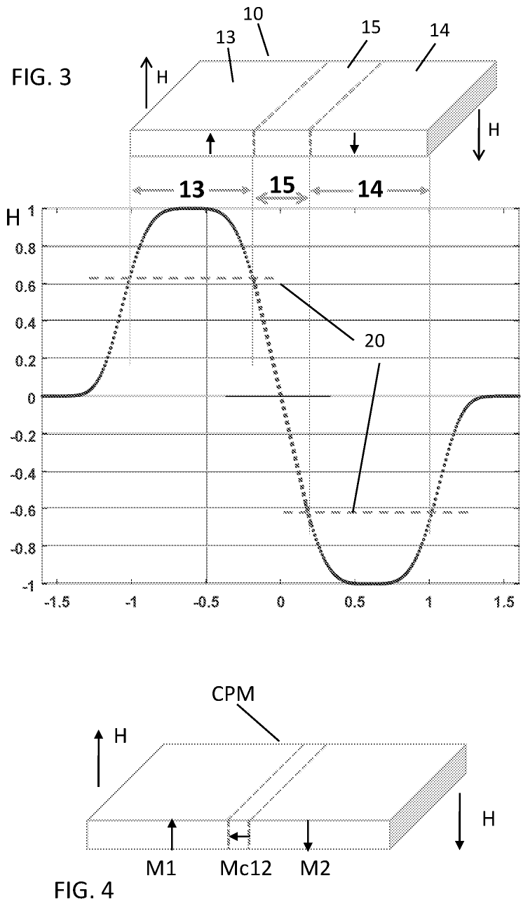

FIG. 3 illustrates the magnetic field distribution from the magnetizing device that sets the magnetization of the PM used for HDD application. This type of magnet can be used for HDD VCM operation when the core region is in a fan shape as seen from the top or a customized shape. To illustrate the working principle, the magnet shown here has a rectangle shape from the top view. The entire magnet requires two regions to have magnetization in opposite directions. Depending on the magnetizing device setup, an external applied field H can be applied to the magnet block 10. On one side, region 13, the magnetic field H is pointing in one direction and exceeds the saturation field Hs 20. On the other side, region 14, the magnetic field His pointing in the opposite direction and exceeds the saturation field Hs 20. The crystalline anisotropy of this PM block is along the out-of-plane direction. This allows the magnet to simultaneously have both regions 13 and 14 with magnetization directions set in opposite directions, as illustrated by the arrows. However, regardless of the method used, there is a center region 15 between regions 13 and 14 where the magnetic field applied is below the saturation field Hs 20 of the PM. The magnet materials in this region 15 have a poorly defined magnetization state and is often referred to as the “dead zone” 15. Since the magnetic field cannot be changed as a step function, the size of the dead zone 15 may vary depending on the magnet geometry and magnetizing device design setup. In practice, it is typically in the order of several hundreds of micrometers to a few millimeters, and sometimes even higher. The existence of the dead zone 15 reduces the magnetic field from the permanent magnet, thereby lowering its performance for motor or actuator applications. Note that the anisotropy direction of the magnet regions 13, 14, and 15 is all aligned in the same direction (out-of-plane direction). The magnetization on the left and right side of the magnet can only be set into parallel or antiparallel directions.

In many applications, instead of using a single piece magnet to achieve the desired magnetic field, two identical magnets are used and magnetized separately. One of the pieces is then flipped by 180° and the two pieces are glued together. This approach increases the manufacturing cost as each piece needs to be handled separately, and also introduces process variations to the PM dimensions. For applications that require accurate alignment, size, and shape, a one-piece magnet solution without variations in magnet thickness is desirable.

FIG. 4 illustrates a CPM as described in an embodiment of the invention. This CPM comprises a first core magnet region M1 and a second core magnet region M2 and a cladding magnet region Mc12. Here, Mc represents the cladding magnet, and 1 and 2 represent the region of Mc12 is between M1 and M2. The magnetization direction of M1 and M2 are opposite to each other, and the magnetization direction of Mc12 is substantially perpendicular to the magnetization direction of M1 and M2. The thickness difference between Mc12 and M1, M2 is less than 5 μm. In a preferred embodiment, the anisotropy direction of the core magnet regions, M1 and M2, are along the out-of-plane directions as illustrated by the arrows in M1 and M2. The anisotropy direction of the cladding magnet region, Mc12, is within the plane as illustrated by the Mc12 arrow.

In an embodiment, this CPM has a thin glue or adhesive layer between the cladding magnet Mc12 and the core magnet M1 and M2. The typical glue thickness is 10 μm or less, and therefore, as illustrated by the dashed line, the non-magnetic region, i.e. adhesive, width is typically 10 μm or less. In this case, the non-magnetic region size is significantly smaller than conventional PM blocks' dead zone dimensions. The cladding magnet Mc12 region provides specific functions, and the overall CPM produces higher efficiency. Traditional manufacturing processes require that the CPM structure be glued together from individual magnet blocks using a magnet assembly process. This process introduces part-to-part variations due to individual parts being made separately. In addition, a large magnetic force pushes away individual magnets, causing either damage to the materials or misalignment. The method described here allows for an integrated CPM structure to be achieved during the manufacturing process, before the magnet is even magnetized.

In another embodiment, this CPM is a single piece of magnet without any glue or coating materials between the core magnet regions (M1 and M2) and the cladding magnet region (Mc12). This design eliminates the need for separate pieces of magnet to be glued or assembled together. The CPM is a single piece of magnet, and there are no non-magnetic or soft magnetic coating materials between the core magnet regions and the cladding magnet region.

The CPM shown here has accurate control of its dimensions, with a thickness variation within 5 micrometers, and in most cases within 1 micrometer or even down to nanometer scale. The composite structure is integrated during the manufacturing process, and the anisotropy direction in the cladding magnet (Mc12) is substantially perpendicular to the anisotropy direction in the core magnet regions (M1 and M2). Our unique manufacturing processes can produce this type of single piece CPM without a dead zone or coating materials between the core magnet regions and the cladding magnet region, and the glue between the two can have a thickness of a few tens of micrometers or less. The thickness of the core magnet and cladding magnet can be kept equal or within a few micrometers such as 5 micrometer or less with respect to each other. This results in a higher performing magnet, or in some applications, the same function can be achieved with a smaller volume of materials, which is crucial for certain applications like those used in cell phones or VCMs.

In another embodiment of the invention, the CPM is made as a single piece without the need for glue or coating materials between the core magnet regions and the cladding magnet region. This eliminates the need for separate pieces of magnet to be assembled or glued together, resulting in a more efficient and streamlined manufacturing process overall. In this embodiment, there is no presence of non-magnetic or soft magnetic materials between the core and cladding magnet regions, further enhancing the magnetic properties of the CPM.

The CPM described in this embodiment has precise control over its dimensions, with thickness variations typically kept within 5 μm, and often within 1 μm. A unique manufacturing method is used to achieve such precise control over the critical dimensions of the individual magnet regions within the composite structure. The composite structure is integrated during the manufacturing process, allowing for the anisotropy direction of the cladding magnet region to be substantially perpendicular to the anisotropy direction of the core magnet regions.

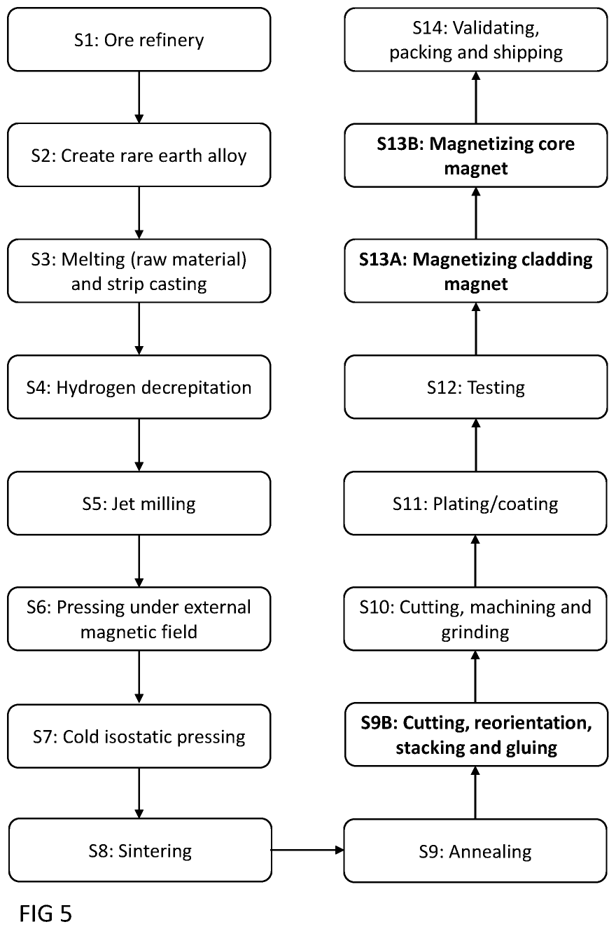

FIG. 5 illustrates the manufacturing process for Neodymium-based CPM s in accordance with an embodiment of the invention. The process steps shown in FIG. 1 are also used for the CPM, with an additional step S9B. In step S9B, the core magnet block is cut into two pieces to create a flat surface, and the cladding magnet is then rotated 90° and glued to the core magnet pieces. The core magnet pieces are not magnetized, so there is no magnetic force pushing the pieces away. Alternatively, the cladding magnet can be magnetized before this step. The resulting glued block is then further processed in step S10 to achieve the desired dimensions.

By cutting, machining, and grinding after step S9B, the thickness of the core magnet regions and cladding magnet region is determined by the same wire cutting step, resulting in virtually no variation in thickness between the two regions. This approach eliminates the need for a magnet assembly process, which can cause physical damage or process variations. The use of a single-piece CPM structure also leads to higher performance or a smaller volume of materials needed to achieve the same function, which is critical for certain applications like those used in cell phones and VCM in HDD.

In the manufacturing process, the Step S13 is replaced by two magnetizing steps, Step S13A and Step S13B. To magnetize the cladding magnet region Mc12, an applied field parallel to the composite magnet surface pointing from M2 to M1 is applied to the CPM. For the core magnet regions M1 and M2, an applied field perpendicular to the magnet surface is applied, and the direction of the applied field in the core magnet regions M1 and M2 is opposite to each other. The applied field fully saturates the core magnet regions M1 and M2 by exceeding the saturation field strength (Hs), and aligns the magnetic domains in the out-of-plane direction. One of the preferred methods is to first magnetize the cladding magnet region, Step S13A, and then the core magnet regions, Step S13B, to obtain the desired properties of the CPM. In some cases, the order of these steps may be reversed.

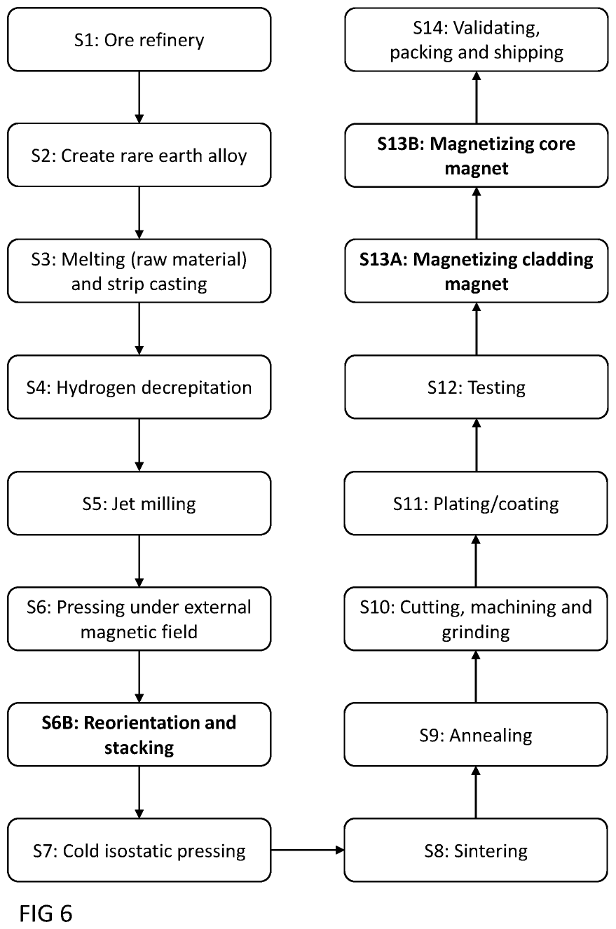

FIG. 6 describes the manufacturing processes for Neodymium based CPM in another embodiment of the invention. In addition to the standard process steps for making Neodymium magnets (as shown in FIG. 1), there are several additional steps and custom apparatus setups required to make the CPM.

Step S6B is a reorientation and stacking step that is unique to this embodiment. In step S13A, the cladding magnet region (Mc12) is magnetized by applying an applied field parallel to the CPM surface and pointing from M2 to M1 (also shown as the Mc12 arrow in FIG. 4). In step S13B, the core magnet regions (M1 and M2) are magnetized by applying an applied field perpendicular to the magnet surface (also shown as M1, M2 arrows in FIG. 4). Additionally, the applied fields in the core magnet regions are opposite to each other and align in the out-of-plane direction. It is preferred to magnetize the cladding magnet region first (S13A), followed by magnetizing the core magnet regions (S13B) to achieve the desired composite magnet property, although under certain conditions the order of these two steps may be reversed.

This step S6B involves reorientation and stacking of the individual magnet pieces to form a composite structure. At this step, the individual magnet pieces are stacked together. The stacked magnets then undergo isostatic pressing (step S7) and sintering (step S8), which cause the stacked magnets to shrink in size and form the composite structure. If the proper process parameters and conditions are used, such as optimized pressure and temperature, the CPM can be formed without the need for any glue or adhesive, resulting in a one-piece CPM with each piece's anisotropy aligned in the desired direction.

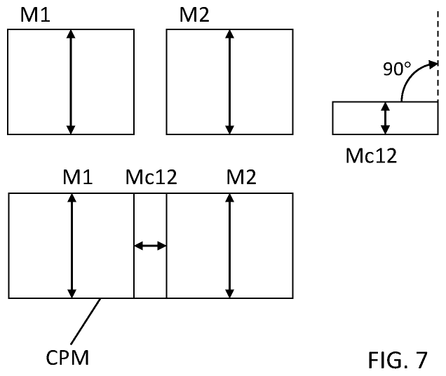

FIG. 7 illustrates the concept of reorientation and stacking used in step S6B in FIG. 6 for the new manufacturing processes of CPMs, as described in an embodiment of the invention. After step S6, individual magnet blocks with target dimensions are produced. Magnets M1, M2, and Mc12 are the magnets fabricated after step S6, with crystalline anisotropy aligned in the out-of-plane direction, as illustrated by the arrows in each block. The thickness of Mc12 is smaller than that of M1 and M2, as determined by the target dimensions of the CPM to be manufactured. In step S6B, the magnet block Mc12 is rotated by 90°, and the magnets M1, Mc12, and M2 are then stacked together to form a one-piece CPM. The entire CPM is then placed in a bag and subjected to isostatic pressing in step S7. During step S7 isostatic pressing and step S8 sintering processes, the size of the CPM is further reduced, but the crystalline anisotropy within each region remains intact. Due to this process change, the process conditions for step S7 isostatic pressing and step S8 sintering will be further optimized, particularly with different pressures used, to ensure the desired CPM structure is achieved.

The pressure applied in steps S6 and S7 is different. During each step, the magnet undergoes further shrinkage of its dimension. To ensure that the material is aligned in the desired direction, a specific pressure may be applied to the sample during the sintering process to ensure that the shrinkage rate is consistent in each direction. Calculating and adjusting the percentage of dimensional change before each step is particularly important in the production of high-performance permanent magnets, where the magnetic anisotropy direction must be highly oriented to achieve a high energy product.

Adding the step of reorientation and stacking (step S6B) allows the cladding magnet region to have an anisotropy direction that is approximately 90° with respect to the core magnet magnetization anisotropy direction in this example. This method of manufacturing CPM s enables the production of a single piece without the use of glue or any other non-magnetic coating material between the core magnet regions and the cladding magnet region, resulting in a CPM with increased efficiency.

FIG. 7 also illustrates the concept of reorientation and stacking used as step S9B in FIG. 5 in the new manufacturing processes for the CPM s as described in an embodiment of the invention. After step S9, the individual magnet blocks are formed without remnant magnetization. The magnets M1, M2, and Mc12 are the magnets fabricated after step S9, with the crystalline anisotropy aligned in the out-of-plane direction, as illustrated by the arrows in each block. The thickness of Mc12 is smaller than that of M1 and M2, as determined by the target dimensions of the CPM to be manufactured. In practice, M1 and M2 can be cut from the same magnet block using a wire cutting method. Mc12 can also be cut from a different magnet block to accurately control the thickness. In step S9B, the magnet block Mc12 is then rotated by 90°, and the magnets M1, Mc12, and M2 are then glued together to form a CPM structure. Since both M1, M2 and Mc12 can be produced from large magnet blocks from existing manufacturing lines, there is little or no waste of materials, except a couple of extra cuttings are utilized. In the gluing process, there is no magnetic force concern if Mc12 is not magnetized. Or it can be easily glued together if Mc12 is magnetized. The M1 and M2 are not magnetized at this stage, therefore, there is no magnetic repelling force between different magnet pieces. The Mc12 force only helps to glue different pieces of magnets together. Since step S9B is applied before step S10, there is no alignment concern and the precise dimension and shape are controlled by step S10 of the current manufacturing process. Since this process is done with large magnet blocks, it is easy to handle and also with reduced cost as compared to magnet assembly methods currently utilized in the field.

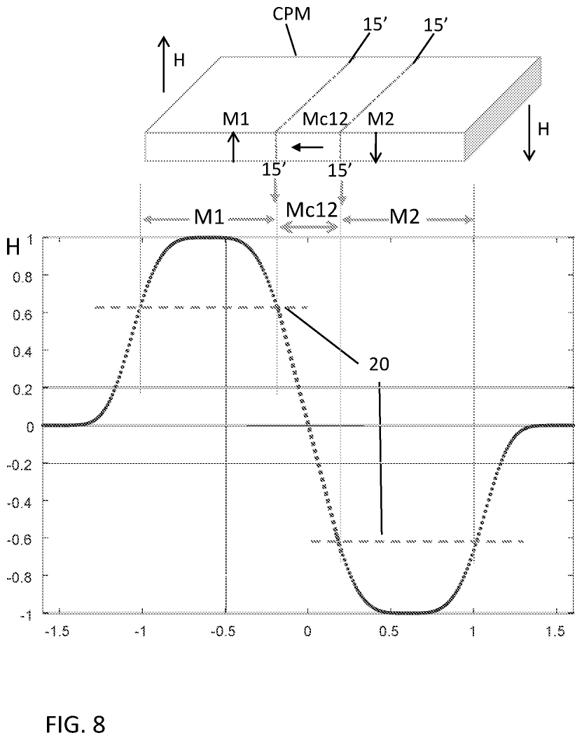

FIG. 8 illustrates the distribution of the magnetic field in the second magnetization step (S13B) and its impact on the CPM for HDD) applications, as described in an embodiment of the invention. The field applied to the core magnet regions M1 and M2 exceeds the coercive field Hc and is oriented in the out-of-plane direction, magnetizing the entire core magnet regions M1 and M2, respectively. In the cladding magnet region Mc12, the applied field drops rapidly, and the majority of the field is along its hard axis direction. This significantly reduces or eliminates the dead zone 15′ between the core magnet regions M1 and the cladding magnet region Mc12, or between the core magnet regions M2 and the cladding magnet region Mc12. The magnetic field plot shows the applied field in the perpendicular or out-of-plane direction set by the magnetizing device. In the cladding magnet region Mc12, even if the magnetic field is not zero, the magnetization in this region will remain in the same direction after the field is removed due to the crystalline anisotropy of the magnet being parallel to the surface.

By using the manufacturing process illustrated in FIGS. 6 and 7 and the two-step magnetizing method, a CPM without a dead zone or non-magnetic interlayer can be produced. Alternatively, for the method used in FIG. 5, a CPM without an additional dead zone can be produced, with the only non-magnetic materials being the glue or adhesive. No poorly magnetized magnetic dead zone is produced using this method. Note that with the two-step magnetization method, the cladding magnet region Mc12 and the core magnet regions M1 and M2 can be magnetized and optimized separately. With proper adjustments, such as a small magnetization field profile or angle change, one can ensure that each individual magnet region is accurately aligned or saturated in the desired direction, ultimately enabling significant improvement of the PM field output or its performance.

Combine the methods shown from FIG. 5 to FIG. 8, one can achieve high performance CPM using different manufacturing approaches. No matter which method to use, an additional step to reorient and stack core magnet and cladding magnet pieces is required before the Step S10 Cutting, machining and grinding.

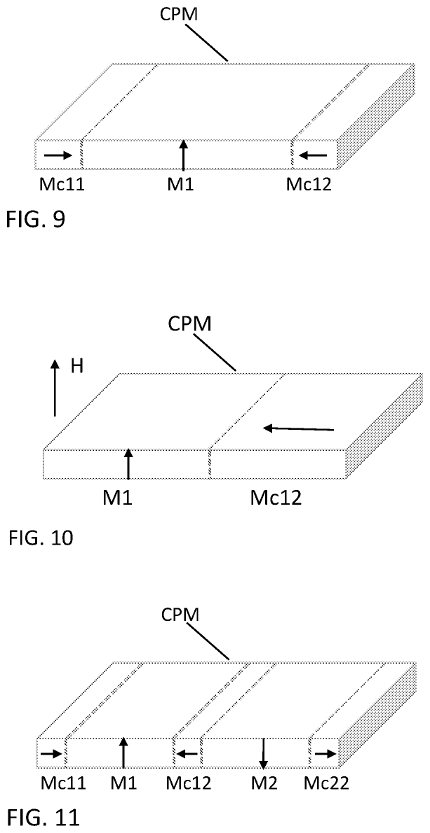

FIG. 9 illustrates a CPM as described in another embodiment of the invention. This composite magnet (CPM) has a core magnet region with magnetization M1 and two cladding magnet regions with magnetizations Mc11 and Mc12. The magnetization direction of M1 is in one direction, while the cladding magnet regions Mc11 and Mc12 have magnetizations that are substantially perpendicular to the magnetization direction of M1 and substantially antiparallel to each other. In a preferred embodiment, the magnetization direction of the core magnet region is along the out-of-plane direction, as indicated by the arrow in the illustration for the core magnet M1. The magnetization direction of the cladding magnet regions is within the plane, as indicated by the arrows in the illustration for the cladding magnets Mc11 and Mc12. The thickness difference between the cladding magnets and the core magnet is within 0.1%. In some embodiments, there is no glue or other non-magnetic coating materials between the core magnet region and the cladding magnet regions. In other embodiments, the composite magnet is glued together, with a glue layer thickness less than 10 μm. The composite structure is integrated during the manufacturing processes, and the anisotropy direction in the cladding magnet regions is substantially perpendicular to the anisotropy direction in the core magnet region. No separate magnetic assembly process is required.

FIG. 10 illustrates a CPM as described in another embodiment of the invention. The CPM comprises a core magnet region M1 and a cladding magnet region Mc12. The letter “Mc” represents the cladding magnet, and the numbers “1” and “2” indicate that the region Mc12 is located on one side of the core magnet M1 and if there is another piece of core magnet M2 is added, the cladding magnet Mc12 will be placed in between M1 and M2. The magnetization direction of M1 is out of the magnet surface plane as illustrated by the M1 arrow. The magnetization direction of Mc12 is substantially perpendicular to magnetization direction M1 as illustrated by the Mc12 arrow, pointing to or away from M1. The thickness difference between Mc12 and M1 is less than 5 μm. In a preferred embodiment, the anisotropy direction of the core magnet regions is along the out-of-plane directions, as indicated by the arrows in M1. The anisotropy direction of the cladding magnet region is within the plane and is indicated by the arrow in Mc12.

In one embodiment, the composite magnet also has a thin layer of glue between the cladding magnet Mc12 and the core magnet M1. This glue layer has a typical thickness of 10 μm or less, as shown by the dashed line, resulting in a non-magnetic region with a width of 10 μm or less. This significantly reduces the size of the non-magnetic region compared to the conventional dead zone dimensions of PM blocks. The cladding magnet Mc12 provides specific functionalities and enhances the overall performance of the CPM.

In traditional manufacturing processes, the composite magnet structure is constructed by gluing together individual magnet blocks. This approach introduces variability in the finished product due to the processes applied to each individual part. Moreover, the strong magnetic forces between the blocks can cause damage or misalignment during assembly. To overcome these challenges, the conventional approach requires special tools and complex assembly processes to align the magnets in different regions with different magnetization directions. However, the method described in this invention allows for the integration of the CPM structure during the manufacturing process, even before each magnet block is magnetized.

In another embodiment of the invention, the CPM is made as a single piece without the need for glue or coating materials between the core magnet regions and the cladding magnet region. This eliminates the need for separate pieces of magnet to be assembled or glued together, resulting in a more efficient and streamlined manufacturing process. In this embodiment, there is no presence of non-magnetic or soft magnetic materials between the core and cladding magnet regions, further enhancing the magnetic properties of the CPM.

The CPM described in this embodiment has precise control over its dimensions, with thickness variations typically kept within 5 μm, and often within 1 μm. A unique manufacturing method is used to achieve this level of control over the critical dimensions of the individual magnet regions within the composite structure. The composite structure is integrated during the manufacturing process, allowing for the anisotropy direction of the cladding magnet region to be substantially perpendicular to the anisotropy direction of the core magnet regions.

This type of CPM can be fabricated as a single piece, without any dead zones or coating materials between the core magnet regions and the cladding magnet region. If a glue material is used, its thickness is kept to 10 μm or less. The thickness of the core magnet and cladding magnet can be kept equal or within 5 μm when assembled, leading to higher performance or allowing for a smaller volume of materials to be used for the same function, which is critical for certain applications such as cell phones and VCM.

FIG. 11 illustrates an embodiment of an integrated CPM. This CPM comprises: a first core magnet region with magnetization M1, a second core magnet region with magnetization M2, a first cladding magnet region with magnetization Mc11, a second cladding magnet region with magnetization Mc12, and a third cladding magnet region with magnetization Mc22.

The magnetization direction of M1 is along one direction and the cladding magnet regions magnetization Mc11 and Mc12 are substantially perpendicular to the magnetization direction of M1, with the magnetization Mc11 and Mc12 being substantially antiparallel to each other. In a preferred embodiment, the magnetization direction of the core magnet region M1 is along the out-of-plane direction, as indicated by the arrow for core magnet region M1. The magnetization direction of the cladding magnet region is within the plane, as indicated by the arrows for cladding magnet regions Mc11 and Mc12.

In one embodiment, the CPM is a single piece without any glue or other non-magnetic coating materials between the core magnet region and the cladding magnet regions. In another embodiment, the magnets may be glued together with a glue layer thickness of less than 10 μm. The thickness difference between the cladding magnets and the core magnet is within 0.1% or 5 μm. The magnet has a composite structure that can be integrated during the manufacturing process, eliminating the need for magnet assembly, and the anisotropy direction in the cladding magnet regions is substantially perpendicular to the anisotropy direction in the core magnet region.

The figures shown above are examples of individual CPM s that can be utilized in various applications, particularly for hard disk drives using CPM s for Voice Coil Motors (VCMs). In various applications, multiple CPM components may be used with specific periodic patterns and shapes and sizes to form magnet structures for high-efficiency motors and generators, improving power density. A more complex structure can be made by adding additional core magnet blocks and cladding magnet blocks, either as Step 6B in FIG. 6 or as Step 9B in FIG. 5, to form a single-piece CPM. The shape of the CPM can be tailored based on the specific requirements of the application or eventually achieved in Step 10. The components forming the CPM do not need to be in the form of rectangles. Some applications may use fan-shaped, trapezoidal, square-shaped, or other custom-shaped components as seen from the top, side, or back views.

The magnets used in this invention have a maximum energy product (BH)max of more than 10 MGOe in either the core magnet region or cladding magnet region. The magnet material may be made of Neodymium-Iron-Boron (NdFeB), Samarium Cobalt (SmCo), ferrite such as Barium-Iron-Oxygen (Ba—Fe—O), Barium-Nickel-Iron-Oxygen (Ba—Ni—Fe—O), Barium-Strontium-Nickel-Iron-Oxygen (Ba—Sr—Ni—Fe—O), and others, or alnico such as Aluminum-Nickel-Cobalt (Al—Ni—Co), Aluminum-Nickel-Cobalt-Iron (Al—Ni—Co—Fe), Aluminum-Nickel-Cobalt-Iron-Copper (Al—Ni—Co—Fe—Cu), and others. The magnet material may also be based on rare earth-transition metal-based permanent magnetic materials such as X—Y or X—Y—Z, where X includes rare-earth elements such as Neodymium (Nd), Samarium (Sm), Gadolinium (Gd), Neodymium-Dysprosium (NdDy), Neodymium-Dysprosium-Terbium-Gadolinium (NdDyTbGd), Neodymium-Dysprosium-Terbium (NdDyTb), Neodymium-Dysprosium-Terbium-Praseodymium (NdDyTbPr), and others; Y includes transition metal elements such as Iron (Fe), Cobalt (Co), Manganese (Mn), Nickel (Ni), Iron-Cobalt (FeCo), Iron-Cobalt-Nickel (FeCoNi), Iron-Cobalt-Nickel-Manganese (FeCoNiMn), and others; and Z includes non-metal elements or other doping elements such as Boron (B), Silicon (Si), Carbon (C), Nitrogen (N), Aluminum (Al), Copper (Cu), Silver (Ag), Zirconium (Zr), and others. Mn-based permanent magnetic materials and transition metal-platinum-based magnetic materials are also possible options. The magnets can be Neodymium-Iron-Boron (NdFeB) based materials with varying concentrations of Neodymium (Nd), or Neodymium-Iron-Boron (NdFeB) based materials with different rare earth element or alloy doping, or rare earth-based composites such as CeAl, Dysprosium and Terbium, Praseodymium. The NdFeB may contain up to 25% Praseodymium instead of Nd. The composite magnet material may be any of the aforementioned magnetic materials.

In various embodiments, the core magnet region has a width to height ratio that is higher than the width to height ratio of the cladding magnet region. In some embodiments, the width to height ratio of the core magnet region is greater than 3:1, while the width to height ratio of the cladding magnet region is less than 2:1. In a preferred embodiment, the width to height ratio of the cladding magnet region is close to 1:1. The smaller width of the cladding magnet region in comparison to the core magnet region allows for optimized magnetic field and magnetic flux in a given space, resulting in higher efficiency without using more PM material. This technology solution improves efficiency without incurring additional materials cost. Without precise control of the dimensions of the cladding magnet region with respect to the core magnet region and its geometry, the benefits of the materials solution will be limited. In practice, the CPM is formed in one piece, and the magnetization in each region is set separately during the manufacturing process. This allows the composite magnet to maintain its size and shape according to design, with performance exceeding existing approaches.

This list of aspects represents different embodiments that are explicitly covered by the present application. It is important to note that these aspects are not meant to limit the scope of the disclosed embodiments or to provide an exhaustive list of all possible embodiments, but are intended to serve as examples of the various options available. Those familiar with the art will easily recognize that the disclosed embodiments can be modified and expanded upon based on the information provided.

1. A composite permanent magnet (CPM) comprising: a first core magnet region M1, a cladding magnet region Mc12, and a second core magnet region M2 from one end to another; the magnetization direction of the core magnet regions M1 and M2 are opposite to each other, while the magnetization direction of the cladding magnet region Mc12 is substantially perpendicular to the magnetization direction of the core magnet regions M1 and M2; there is no glue, non-magnetic coating, soft magnetic coating, or other non-magnetic materials between the core magnet regions M1, M2, and the cladding magnet region Mc12.

2. The CPM, as described in aspect 1, wherein the size and width of the core magnet regions M1 and M2 are approximately the same.

3. The CPM, as described in aspect 1, wherein the size and width of the cladding magnet region Mc12 are smaller than the size and width of the core magnet regions M1 and M2.

4. The CPM, as described in aspect 1, wherein the magnetization direction of the core magnet regions M1 and M2 is substantially perpendicular to the surface of the CPM, and the magnetization direction of the cladding magnet region Mc12 is parallel to the surface of the CPM, extending from M2 to M1 or from M1 to M2.

5. The CPM, as described in aspect 1, with a shape that is in the form of a fan, trapezoid, rectangle, or any other preset shape, as viewed from a top-down perspective. The shape of the composite magnet, as well as the core magnet regions M1 and M2 and the cladding magnet region Mc12, are designed accordingly.

6. The CPM, as described in aspect 1, with the height of the core magnet regions M1 and M2, and the height of the cladding magnet region Mc12, being approximately the same.

7. The CPM, as described in aspect 1, is made of at least one of the following materials: rare earth-transition metal-based permanent magnetic material, manganese-based permanent magnetic material, transition metal-platinum-based magnetic material, Iron-Nitride (Fe—N), Neodymium-based permanent magnetic material such as Neodymium-Iron-Boron based materials with varying Neodymium concentration or Neodymium-Iron-Boron with other doping elements, such as dysprosium, Samarium Cobalt (SmCo), or Samarium Cobalt (SmCo) alloys with different percentages of other elements.

8. The CPM, as described in aspect 1, wherein the crystalline anisotropy of the core magnet regions M1 and M2 are aligned in the same direction and the crystalline anisotropy of the cladding magnet region Mc12 is perpendicular to that of the core magnet regions M1 and M2.

9. The CPM, as described in aspect 1, wherein the core magnet regions M1 and M2 are made of the same material.

10. The CPM, as described in aspect 1, wherein the core magnet regions M1 and M2 and the cladding magnet region Mc12 are made of the same material.

11. The CPM, as described in aspect 1, is composed of core magnet regions M1 and M2 that use different materials than the cladding magnet region Mc12.

12. The CPM, as described in aspect 1, has a shape that is rectangular or trapezoidal in the back view or side view.

13. The CPM, as described in aspect 1, has a width ratio of M1 to Mc12 of approximately 3:1, as measured from the back view.

14. The CPM, as described in aspect 1, has a width ratio of M1 to Mc12 of approximately 4:1, as measured from the back view.

15. The CPM, as described in aspect 1, has a width ratio of M1 to Mc12 ranging from 2:1 to 10:1, as measured from the back view.

16. The CPM, as described in aspect 1, wherein the ratio of the width of the cladding magnet region Mc12 to its height is approximately 1:1, as viewed from the back.

17. The CPM, as described in aspect 1, with a ratio of the width of the cladding magnet region Mc12 to its height of approximately 2:1, as viewed from the back.

18. The CPM, as described in aspect 1, with a ratio of the width of the cladding magnet region Mc12 to its height of approximately 3:2, as viewed from the back.

19. The CPM, as described in aspect 1, with a ratio of the width of the cladding magnet region Mc12 to its height between 3:1 and 1:3, as viewed from the back.

20. The CPM, as described in aspect 1, with the cladding magnet region Mc12 having a width to height ratio of approximately 3:2, as viewed from the back.

21. The CPM, as described in aspect 1, which is made of the core magnet regions M1, M2, and the cladding magnet region Mc12 pressed together as a single piece.

22. The CPM, as described in aspect 1, with the thickness or the height difference between the core magnet regions M1 and M2, and the cladding magnet region Mc12 is within 20 μm, 10 μm, or 5 μm.

23. The CPM, as described in aspect 1, wherein the core magnet regions M1 and M2 has approximately the same size and width.

24. The CPM, as described in aspect 1, with the cladding magnet region Mc12 having a smaller size and width compared to the core magnet regions M1 and M2.

25. The CPM, as described in aspect 1, with the magnetization direction of the core magnet regions M1 and M2 perpendicular to the CPM surface and the magnetization direction of Mc12 parallel to the CPM surface, either from M2 to M1 or from M1 to M2.

26. The CPM, as described in aspect 1, is characterized by a fan-shaped, rectangle-shaped, or trapezoid-shaped core magnet regions M1 and M2 and cladding magnet region Mc12, as viewed from the top.

27. The CPM, as described in aspect 1, is also characterized by a rectangle-shaped, trapezoid-shaped core magnet regions M1 and M2 and cladding magnet region Mc12, as viewed from the back or side.

28. The CPM, as described in aspect 1, has core magnet regions M1 and M2 and a cladding magnet region Mc12 with approximately the same height.

29. The CPM, as described in aspect 1, is made of at least one of the following materials: alnico, ferrite, a rare earth-transition metal-based permanent magnetic material, a manganese-based permanent magnetic material, a transition metal-platinum-based magnetic material, Iron-Nitride (Fe—N), a Neodymium-based permanent magnetic material, such as Neodymium-Iron-Boron based materials with different Neodymium concentration percentages or Neodymium-Iron-Boron with other dopants, such as dysprosium.

30. The CPM, as described in aspect 1, may also include coverings or coatings, such as a Nickel-plated coating, Zinc coating, Passivation, Epoxy-coating, Aluminum-coating, or other painting materials.

31. The CPM, as described in aspect 1, further comprises cladding magnet regions Mc11 and Mc22 on the opposite ends of core magnet regions M1 and M2, respectively. The magnetization direction of cladding magnet regions Mc11 and Mc22 is substantially perpendicular or at an angle between 30 to 90 degrees relative to the magnetization direction of core magnet regions M1 and M2, respectively.

32. The CPM, as described in aspect 31, has a cladding magnet region Mc11 with a magnetization direction that is substantially perpendicular to the magnetization direction of core magnet region M1.

33. The CPM as described in aspect 31, the angle between the magnetization direction of cladding magnet region Mc11 and the magnetization direction of core magnet region M1 is between 30 and 150 degrees.

34. The CPM, as described in aspect 31, the size and width of cladding magnet regions Mc11 or Mc12 are smaller than the size and width of core magnet regions M1 or M2.

35. The CPM, as described in aspect 31, is characterized by one or more of its cladding magnet regions or core magnet regions Mc11, M1, Mc12, M2, or Mc22 being shaped as a rectangle, fan, or trapezoid from the top view or the back view.

36. The CPM, as described in aspect 31, has one or more cladding magnet regions Mc11, Mc12, and Mc22 and core magnet regions M1 and M2 with custom-designed shapes.

37. The CPM as described in aspect 31, wherein the shapes of one or more of the cladding and core magnet regions can be rectangular or trapezoidal, as seen in the back view or side view.

38. The CPM as described in aspect 31, wherein the thickness or the height difference of the cladding and core magnet regions is within 20 μm, 10 μm or 5 μm.

39. The CPM as described in aspect 31, wherein the cladding and core magnet regions are made of at least one of the following materials: alnico, ferrite, a rare earth-transition metal-based permanent magnetic material, a manganese-based permanent magnetic material, a transition metal-platinum-based magnetic material, Iron-Nitride (Fe—N), a Neodymium-based permanent magnetic material, such as Neodymium-Iron-Boron based materials with different percentage of Neodymium (Nd) concentration or Neodymium-Iron-Boron with other doping materials, such as dysprosium.

40. The CPM as described in aspect 31, wherein the shape of one or more of the cladding and core magnet regions can be fan-shaped, rectangular, or trapezoidal from the top view.

41. The CPM as described in aspect 31, wherein from the back view or side view, the shape of one or more of the cladding and core magnet regions can be rectangular or trapezoidal.

42. The CPM as described in aspect 31, wherein the size and width of the core magnet regions M1 and M2 are approximately the same.

43. The CPM as described in aspect 31, wherein the size and width of the cladding magnet Mc12 is smaller than the core magnet regions M1 and M2.

44. The CPM as described in aspect 31, wherein the size and width of the cladding magnet Mc11 is smaller than the core magnet region M1.

45. The CPM as described in aspect 31, wherein the magnetization direction of M1 and M2 of the CPM is perpendicular to the CPM surface, while the magnetization direction of Mc12 is parallel to the CPM surface pointing from M2 to M1.

46. The CPM, as described in aspect 31, uses the same materials for both the cladding magnet regions Mc11, Mc12, and Mc22 and the core magnet regions M1 and M2.

47. The CPM, as described in aspect 31, uses different materials for the cladding magnet regions Mc11, Mc12, and Mc22 and the core magnet regions M1 and M2.

48. The CPM, as described in aspect 31, wherein the shape of the cladding magnet regions Mc11, Mc12, or Mc22 or the core magnet regions M1 or M2 in the CPM, can be in the form of a fan, rectangle, or trapezoid shape when viewed from the top.

49. The shape of the cladding magnet regions Mc11, Mc12, or Mc22 or the core magnet regions M1 or M2 in the CPM, as described in aspect 31, can be in the form of a rectangle or trapezoid shape when viewed from the back or side.

50. The ratio of the width of the core magnet region M1 to the width of the cladding magnet region Mc12 in the CPM, as described in aspect 31, is approximately 3:1 when viewed from the back.

51. The ratio of the width of the core magnet region M1 to the width of the cladding magnet region Mc12 in the CPM, as described in aspect 31, is approximately 4:1 or higher when viewed from the back.

52. The ratio of the width of the core magnet region M1 to the width of the cladding magnet region Mc12 in the CPM, as described in aspect 31, is between 2:1 and 10:1 when viewed from the back.

53. The ratio of the width of the cladding magnet region Mc12 to its height in the CPM, as described in aspect 31, is approximately 1:1 when viewed from the back.

54. The ratio of the width of the core magnet region M1 to its height in the CPM, as described in aspect 31, is between 3:1 and 10:1 when viewed from the back.

55. The ratio of the width of the cladding magnet region Mc12 to its height in the CPM, as described in aspect 31, is approximately 2:1 when viewed from the back.

56. The CPM described in aspect 31 has a cladding magnet region (Mc12) with a ratio of width to height of approximately 3:2, as seen from the back view.

57. In the CPM described in aspect 31, the ratio of the width of the cladding magnet region Mc12 to its height ranges from 3:1 to 1:3, as measured from the back view.

58. The CPM described in aspect 31 has a cladding magnet region Mc12 with a ratio of width to height of approximately 3:2, as seen from the back view.

59. The core magnet regions M1 and M2 and the cladding magnet region Mc12 in the CPM described in aspect 31 are joined together to form a single piece.

60. The size and width of the core magnet regions M1 and M2 in the CPM described in aspect 31 are similar.

61. The size and width of the cladding magnet region Mc12 in the CPM described in aspect 31 are smaller than the size and width of the core magnet regions M1 and M2.

62. In the CPM described in aspect 31, the magnetization direction of the core magnet regions M1 and M2 is perpendicular to the surface of the composite magnet, while the magnetization direction of the cladding magnet region Mc12 runs parallel to the surface from M2 to M1 or from M1 to M2.

63. The core magnet regions M1 and M2 and the cladding magnet region Mc12 in the CPM described in aspect 31 can be fan-shaped, rectangular, or trapezoidal in shape as seen from the top view.

64. The single piece CPM comprises a core magnet region M1 and a cladding magnet region Mc12 with magnetization directions forming an angle between 30 and 150 degrees. There is no glue, magnetic coating, or other non-magnetic or soft magnetic materials between the two regions. The composite magnet has a magnetic energy product (BH)max greater than 10 MGOe, 12 MGOe, or 15 MGOe for either the core magnet region or the cladding magnet region.

65. The CPM described in aspect 64 has magnetization directions of the core magnet region M1 and cladding magnet region Mc12 that are substantially perpendicular to each other.

66. The CPM described in aspect 65 further comprises a second core magnet region M2 adjacent to the cladding magnet region Mc12. The magnetization direction of the core magnet region M2 is substantially opposite to that of the core magnet region M1.

67. In the CPM described in aspect 66, the size or width of the core magnet regions M1 and M2 is larger than that of the cladding magnet Mc12.

68. The size or width of the core magnet regions M1 and M2 and the cladding magnet region Mc12 in the CPM described in aspect 66 follow the same rules as outlined in aspects 12-22.

69. The shape of the core magnet regions M1, M2 or the cladding magnet region Mc12 in the CPM described in aspect 66 is rectangular, trapezoidal, or fan-shaped from a top view.

70. The shape of the core magnet regions M1, M2 or the cladding magnet region Mc12 in the CPM described in aspect 66 is rectangular, trapezoidal, or fan-shaped from a back or side view.

71. The CPM described in aspect 66 further comprises additional cladding magnet regions Mc11 and Mc22 adjacent to the core magnet regions M1 and M2, respectively. The magnetization direction of the cladding magnet regions Mc11 and Mc22 forms an angle between 30 and 150 degrees with the magnetization direction of the core magnet regions M1 and M2.

72. The CPM described in aspect 64 further includes another cladding magnet region Mc11 on the opposite side of the core magnet region M1, away from the cladding magnet region Mc12. The magnetization direction of the cladding magnet region Mc11 forms an angle between 30 and 150 degrees with the magnetization direction of the core magnet M1.

73. In the CPM described in aspect 72, the magnetization direction of the cladding magnet region Mc11 and the core magnet region M1 are substantially perpendicular to each other.

74. In the CPM described in aspect 73, the magnetization direction of the cladding magnet region Mc11 and the other cladding magnet region Mc12 are substantially antiparallel to each other.

75. In the CPM described in aspect 74, the size of the cladding magnet Mc11 is less than ¼ of the size of the core magnet M1.

76. A CPM comprises: a series of core magnet regions M1, M2, . . . , Mn, where n is a positive integer; a series of cladding magnet regions Mc11, Mc12, . . . , Mc1m adjacent to each of the core magnet regions, where m is an integer and m is equal to or greater than zero; and m+n is equal to or greater than 2. The magnetization direction of each of the core magnet regions is along a certain direction, and the magnetization direction of the cladding magnet regions and the magnetization direction of the adjacent core magnet region form an angle between 30 and 150 degrees. There is no glue, magnetic coating, or other non-magnetic material between the core magnet region and the cladding magnet region. The magnetic materials energy product (BH)max is higher than 10MGOe for at least one of the core magnet regions or the cladding magnet regions.

77. The CPM as described in aspect 76, with the magnetization direction of the cladding magnet region being substantially perpendicular to the magnetization direction of the adjacent core magnet region.

78. The CPM as described in aspect 76, with the size and width of the cladding magnet region being smaller than the size and width of the adjacent core magnet region.

79. The CPM as described in aspect 76, with the magnetization direction of the neighboring core magnet regions being substantially antiparallel to each other.

80. The CPM as described in aspect 76, with the magnetic materials energy product (BH)max being higher than 15MGOe for at least one of the core magnet regions or the cladding magnet regions.

81. A CPM comprising: a first core magnet region M1, a cladding magnet region Mc12, and a second core magnet region M2, from one end to another. The magnetization direction of the core magnet regions M1 and M2 is opposite to each other, and the magnetization direction of the cladding magnet region Mc12 is substantially perpendicular to the magnetization direction of the core magnet regions M1 and M2. There is glue between the core magnet regions M1, M2, and the cladding magnet region Mc12, with a width or thickness of 20 μm or less.

82. The CPM as described in aspect 81, with the size and width of the core magnet regions M1 and M2 being approximately the same.

83. The CPM as described in aspect 81, with the size and width of the cladding magnet region being smaller than the size and width of the core magnet regions M1 and M2.

84. The CPM as described in aspect 81, with the magnetization direction of the core magnet regions M1 and M2 being substantially perpendicular to the surface of the CPM, and the magnetization direction of the cladding magnet region Mc12 being parallel to the surface of the CPM from M2 to M1, or from M1 to M2.

85. The CPM as described in aspect 81, with the shape of the composite magnet, the core magnet regions M1 and M2, and the cladding magnet region Mc12 being fan-shaped, trapezoidal, rectangular, or any predetermined shape as viewed from the top view.

86. The CPM, as described in aspect 81, has core magnet regions M1 and M2 and a cladding magnet region Mc12, where the height of all three regions is approximately equal.

87. The CPM, as described in aspect 81, is made of at least one of the following materials: a rare earth-transition metal-based permanent magnetic material, a manganese-based permanent magnetic material, a transition metal-platinum-based magnetic material, Iron-Nitride (Fe—N), Neodymium-based permanent magnetic material, such as Neodymium-Iron-Boron with varying Neodymium concentration, or Neodymium-Iron-Boron with other dopants like dysprosium, Samarium Cobalt (SmCo), or Samarium Cobalt with varying percentages of other elements.

88. The CPM, as described in aspect 81, has core magnet regions M1 and M2 with crystalline anisotropy aligned in the same direction, and the cladding magnet region Mc12 with crystalline anisotropy perpendicular to that of the core magnet regions.

89. The CPM, as described in aspect 81, has core magnet regions M1 and M2 made of the same material.

90. The CPM, as described in aspect 81, has core magnet regions M1 and M2 and the cladding magnet region Mc12 made of the same material.

91. The CPM, as described in aspect 81, has core magnet regions M1 and M2 made of a different material than the cladding magnet region Mc12.

92. The CPM, as described in aspect 81, has a rectangle or trapezoid shape as viewed from the back or side.

93. The CPM, as described in aspect 81, has a ratio of the width of the core magnet regions M1 to the width of the cladding magnet region Mc12 of approximately 3:1 as viewed from the back.

94. The CPM, as described in aspect 81, has a ratio of the width of the core magnet regions M1 to the width of the cladding magnet region Mc12 of approximately 4:1 as viewed from the back.

95. The CPM, as described in aspect 81, has a ratio of the width of the core magnet regions M1 to the width of the cladding magnet region Mc12 ranging from 2:1 to 10:1 as viewed from the back.

96. The CPM, as described in aspect 81, has a ratio of the width to the height of the cladding magnet regions Mc12 of approximately 1:1, as viewed from the back.

97. The CPM, as described in aspect 81, has a ratio of the width to the height of the cladding magnet regions Mc12 of approximately 1:1, as viewed from the back.

98. The CPM, as described in aspect 81, has a ratio of the width to the height of the cladding magnet regions Mc12 of approximately 2:1, as viewed from the back.

99. The CPM, as described in aspect 81, has a ratio of the width to the height of the cladding magnet regions Mc12 of approximately 3:2, as viewed from the back.

100. The CPM, as described in aspect 81, has a ratio of the width to the height of the cladding magnet regions Mc12 between 3:1 and 1:3, as viewed from the back.

101. The CPM, as described in aspect 81, has a ratio of the width to the height of the cladding magnet regions Mc12 of approximately 3:2, as viewed from the back.

102. The core magnet regions M1, M2, and the cladding magnet region Mc12 are pressed together to form a single piece of magnet in the CPM, as described in aspect 81.

103. The CPM, as described in aspect 81, has a thickness difference between the core magnet regions M1, M2, and the cladding magnet region Mc12 within 10 μm.

104. A CPM comprises of a core magnet region M1 and a cladding magnet region Mc12. The magnetization direction of the core magnet region M1 and the cladding magnet region Mc12 form an angle between 30 and 150 degrees, with no glue, magnetic coating, or other non-magnetic materials between them. The size or width of the core magnet regions M1 is larger than the cladding magnet region Mc12, and the magnet has a magnetic materials energy product (BH)max higher than 10 MGOe for the core magnet region M1 and/or the cladding magnet region Mc12.

105. The CPM, as described in aspect 104, has a magnetization direction of the core magnet region M1 and the cladding magnet region Mc12 that are substantially perpendicular to each other.

106. The CPM, as described in aspect 105, further comprises a second core magnet region M2 adjacent to the cladding magnet region Mc12. The magnetization direction of the core magnet region M2 is substantially in the opposite direction compared to the magnetization direction of the core magnet region M1.

107. The CPM, as described in aspect 106, has a width to height ratio of the core magnet regions M1 and M2 between 2:1 and 10:1 and the width to height ratio of the cladding magnet regions Mc12 between 1:3.5 and 2.5:1 or between 1:3 and 3:1 when measured from the back view.

108. The CPM, as described in aspect 106, has a rectangular, trapezoidal, fan-shaped, or custom-defined shape of the core magnet regions M1 and M2 or the cladding magnet region Mc12 when viewed from the top.

109. The CPM, as described in aspect 106, further comprises additional cladding magnet regions Mc11 and Mc22 next to the core magnet regions M1 and M2 respectively. The magnetization direction of the cladding magnet regions Mc11 and Mc22 and the magnetization direction of the core magnet regions M1 and M2 form an angle between 30 and 150 degrees.

110. The CPM, as described in aspect 104, also comprises another cladding magnet region Mc11 on the opposite side of the core magnet region M1 with respect to the cladding magnet region Mc12. The magnetization direction of the cladding magnet region Mc11 and the magnetization direction of the core magnet region M1 form an angle between 30 and 150 degrees.

111. The CPM, as described in aspect 110, has a substantially perpendicular magnetization direction of the cladding magnet region Mc1l and the magnetization direction of the core magnet region M1.

112. The CPM, as described in aspect 111, has a substantially antiparallel magnetization direction of the cladding magnet region Mc1 and the other cladding magnet region Mc12.

113. A CPM consists of a core magnet region M1 and a cladding magnet region Mc12. The magnetization direction of the core magnet region M1 and the magnetization direction of the cladding magnet region Mc12 form an angle between 30 and 150 degrees. The glue between the core magnet region M1 and the cladding magnet region Mc12 has a width of 20 μm or less. The difference in thickness between the cladding magnet and the core magnet is less than 10 μm or less than 0.1% of the thickness of the core magnet. The size of the cladding magnet Mc12 is smaller than the size of the core magnet M1. The magnet has a magnetic energy product (BH)max higher than 10MGOe for either the core magnet region M1 or the cladding magnet region Mc12.

114. The CPM, as described in aspect 113, further comprises a second core magnet region M2 adjacent to the cladding magnet region Mc12. The magnetization direction of the core magnet region M2 is substantially in the opposite direction compared to the magnetization direction of the core magnet region M1.

115. The CPM, as described in aspect 114, has a cladding magnet Mc12 region with a magnetization direction that is substantially perpendicular to the magnetization direction of the adjacent core magnet M1 region.

116. The CPM, as described in aspect 114, has neighboring core magnet regions M1 and M2 with magnetization directions that are substantially antiparallel to each other.

117. The CPM, as described in aspect 114, has a width-to-height ratio of the core magnet regions M1 and M2 between 2:1 and 10:1 and a width-to-height ratio of the cladding magnet regions Mc12 between 1:3 and 3:1, as measured from the back view.

118. The CPM, as described in aspect 114, has a core magnet region M1, M2 or cladding magnet region Mc12 with a shape that is rectangular, trapezoidal, fan-shaped, or any custom-defined shape from the top view.

119. A method to produce a CPM with a high energy product (BH)max larger than 10MGOe in the core region involves an additional step: reorienting and stacking multiple magnet blocks, where the smaller piece corresponds to the cladding magnet Mc12. The cladding magnet has a magnetic crystalline anisotropy direction with an angle between 30-150 degrees with respect to the magnetic crystalline anisotropy direction of the larger core magnet piece M1 and/or M2. This is performed before the steps of cutting, machining, and grinding and before magnetizing the CPM.

120. The method to produce a CPM, as described in aspect 119, includes using the step in claim 119 after the magnet block has been formed by pressing under a magnetic field but before the step of isostatic pressing.

121. The method to produce a CPM, as described in aspect 119, includes using the step in aspect 119 after the sintering and annealing process. An optional wire cutting may be used to split the core magnet regions before reorientation and stacking, define cladding region width and shape and a glue is applied between the cladding magnet block and core magnet blocks.

122. The method to produce a CPM, as described in aspect 119, involves conducting the cutting, machining, and grinding process after the annealing process or the cutting, reorientation, stacking and gluing process whichever occurs later, forming the CPM structure.

123. The method to produce a CPM, as described in aspect 119, further comprises a two-step magnetizing process in which the cladding magnet region Mc12 and the core magnet region M1 are magnetized separately. The two-step magnetizing process starts after the cutting, machining, and grinding process, and the order of these two steps may be switched.

125. The method to produce CPM as described in aspect 119, further comprising a step of applying a protective coating on the surface of the CPM to enhance durability and longevity.

126. The method to produce CPM as described in aspect 119, wherein the protective coating is applied by dipping, spray coating, electroplating, or any other suitable method.

127. The method to produce CPM as described in aspect 119, wherein the cladding magnet Mc12 region is made of soft magnetic materials such as FeNi or any other suitable material selected based on specific requirements such as magnetic permeability and cost effectiveness.

128. The method to produce CPM as described in aspect 119, wherein the composite magnet structure is optimized for specific applications such as electric motors, generators, or any other application that requires high magnetic energy density, through proper selection of magnetic materials, dimensions, and magnetization directions.

129. The method to produce CPM as described in aspect 119, wherein the core magnet regions M1 and M2 are made of NdFeB, SmCo based magnet or any other high energy density magnetic material selected based on specific requirements such as temperature stability and magnetic performance.

130. The CPM as described in aspect 119, wherein the magnet blocks are stacked with the magnetization directions of the core magnet regions M1 and M2 alternating in direction.

131. The method to produce CPM as described in aspect 119, further comprising a heat treatment step to improve the magnetic properties of the CPM.

132. The method to produce CPM as described in aspect 119, further comprising a surface treatment step to improve the mechanical properties of the CPM, such as surface hardness or corrosion resistance.

133. The CPM as described in aspect 114, further comprising a protective coating layer on the surface of the magnet to protect against corrosion and wear.

134. The CPM as described in aspect 114, wherein the core magnet regions M1 and M2 are made of NdFeB, SmCo, or any other high-performance magnetic material.

135. The CPM as described in aspect 114, wherein the cladding magnet Mc12 region is made of soft magnetic materials such as FeNi or any other suitable material.

136. The CPM as described in aspect 114, wherein the composite magnet structure is optimized for specific applications such as electric motors, generators, or any other application that requires high magnetic energy density.

137. The CPM as described in aspect 114, wherein the cladding magnet region Mc12 is made of a different magnetic material than the core magnet regions M1 and M2.

138. The CPM as described in aspect 114, wherein the cladding magnet region Mc12 has a higher coercive field compared to the core magnet regions M1 and M2.

139. The CPM as described in aspect 114, wherein the cladding magnet region Mc12 has a higher remanence compared to the core magnet regions M1 and M2.

140. The CPM as described in aspect 114, wherein the CPM is used in applications such as electric motors, generators, wind turbines, and other applications requiring high magnetic energy density.

141. The CPM as described in aspect 114, wherein the cladding magnet Mc12 is composed of a rare earth element selected from the group consisting of Nd, Pr, Dy, Tb, Ho, Er, Tm, Yb, Lu, Sm and combinations thereof.

142. The CPM as described in aspect 141, wherein the cladding magnet Mc12 is made of NdFeB based material.

143. The CPM as described in aspect 141, wherein the cladding magnet Mc12 is made of SmCo or SmCo based material.

144. The method to produce CPM as described in aspect 119, further comprising the step of selecting the appropriate rare earth element for the cladding magnet Mc12 based on the desired magnetic properties and the required performance of the CPM.

145. The method to produce CPM as described in aspect 144, further comprising the step of adjusting the magnetic properties of the cladding magnet Mc12 by adding or changing the composition of the rare earth element.

145. The method to produce CPM as described in aspect 119, further comprising the step of coating the CPM with a protective layer to prevent corrosion and increase its durability.

146. The CPM as described in aspect 114, wherein the core magnet regions M1 and M2 are composed of a rare earth element selected from the group consisting of Nd, Pr, Dy, Tb, Ho, Er, Tm, Yb, Lu, Sm and combinations thereof.

147. The CPM as described in aspect 146, wherein the core magnet regions M1 and M2 are made of NdFeB based material.

148. The CPM as described in aspect 146, wherein the core magnet regions M1 and M2 are made of SmCo or SmCo based material.

149. The CPM as described in aspect 114, wherein the cladding magnet Mc12 and the core magnet regions M1 and M2 are made of different magnetic materials with distinct magnetic properties.

150. The CPM as described in aspect 114, wherein the cladding magnet Mc12 has a lower magnetic permeability than the core magnet regions M1 and M2.

151. The CPM as described in aspect 114, wherein the cladding magnet Mc12 is designed to have a higher resistance to demagnetization compared to the core magnet regions M1 and M2.

152. The method to produce CPM as described in aspect 119, further comprising the step of selecting the appropriate rare earth element for the core magnet regions M1 and M2 based on the desired magnetic properties and the required performance of the CPM.

153. The method to produce CPM as described in aspect 119, further comprising the step of adjusting the magnetic properties of the core magnet regions M1 and M2 by adding or changing the composition of the rare earth element.

154. The method to produce CPM as described in aspect 119, further comprising the step of selecting the appropriate magnetic materials for the cladding magnet Mc12 and the core magnet regions M1 and M2 to achieve the desired magnetic properties and performance of the CPM.

155. The method to produce CPM as described in aspect 119, further comprising the step of adjusting the magnetic permeability of the cladding magnet Mc12 and the core magnet regions M1 and M2 to achieve the desired magnetic properties and performance of the CPM.

In various applications, CPM components can be utilized in periodic patterns and with shapes and sizes to form magnet structures for high-efficiency motors and generators, resulting in improved power density. By adding an additional core magnet block and cladding magnet block in step S6B or step S9B, a more complex structure can be made to form a one-piece CPM. The detailed shape of the CPM can be customized to meet specific application needs, and the magnet components do not have to be in a rectangular shape. Some applications may require fan, trapezoid, or square shapes, as seen from different views. Additionally, the magnet materials used must have a maximum energy product (BH)max of higher than 10MGOe for the core magnet region and/or cladding magnet region.

The embodiments described herein were chosen to best explain the principles and practical application of the invention to persons skilled in the art. However, modifications and variations can be made to the exemplary embodiments described above without departing from the scope of the invention. Therefore, all matter contained in the foregoing description and shown in the accompanying drawings should be interpreted as illustrative and not limiting. The scope of the invention should be defined in accordance with the following claims and their equivalents. Modifications and variations may be made to the disclosed embodiments while remaining within the spirit and scope of the method, system and apparatus. The implementations described above and other implementations are within the scope of the following claims.

Utilizing multiple CPM components with specific periodic patterns and shapes can result in high-efficiency motor and generator magnet structures, improving power density. By adding an additional core magnet block and cladding magnet block in step S6B or in step S9B, a more complex structure can be formed to create a one-piece CPM. The CPM can be customized to fit specific application needs, and the magnet components do not have to be in a rectangular shape. In some cases, the components can have fan, trapezoid, or square shapes as viewed from different angles. Additionally, the magnet materials used should have a maximum energy product (BH)max of higher than 10MGOe for either the core magnet region or cladding magnet region. In some applications, the maximum energy product (BH)max for the cladding magnet region can be smaller than the maximum energy product (BH)max for the core magnet region. In other applications, either the core magnet region or the cladding magnet region can use materials with maximum energy product (BH)max less than 10MGOe, but the maximum energy product (BH)max in other region still have to use the materials with maximum energy product (BH)max higher than 10MGOe.

The embodiments described herein are intended to provide the best explanation of the invention's principles and practical application to persons skilled in the art. While modifications can be made to the exemplary embodiments, all matter contained in the description and drawings should be interpreted as illustrative and not limiting. Therefore, the scope of the invention should be defined in accordance with the following claims and their equivalents. Modifications and variations to the disclosed embodiments can be made while remaining within the scope of the method, system, and apparatus.

Modifications and variations may be made to the disclosed embodiments while remaining within the spirit and scope of the method, system, and apparatus. The implementations described above and other implementations are within the scope of the following claims.

What is claimed is:

1. A composite permanent magnet (CPM) comprising:
a core magnet region M1 and a cladding magnet region Mc12, wherein:
the magnetization direction of the core magnet region M1 and the magnetization direction of the cladding magnet region Mc12 form an angle between 30 and 150 degrees;
there is no glue, magnetic coating, or other non-magnetic material between the core magnet region M1 and the cladding magnet region Mc12;
the size or width of the core magnet region M1 is larger than the cladding magnet region Mc12;
the magnetic material in the CPM has an energy product (BH)max of higher than 10 MGOe for the core magnet region M1 or the cladding magnet region Mc12.

2. The CPM according to claim 1, wherein
the magnetization direction of the core magnet region M1 and the magnetization direction of the cladding magnet region Mc12 are substantially perpendicular to each other.

3. The CPM according to claim 2, further comprising
a second core magnet region M2 adjacent to the cladding magnet region Mc12, wherein
the magnetization direction of the core magnet region M2 is substantially in the opposite direction to the magnetization direction of the core magnet region M1.

4. The CPM according to claim 3, wherein
the width-to-height ratio of the core magnet regions M1 and M2 is between 2:1 and 10:1;
the width-to-height ratio of the cladding magnet region Mc12 is between 1:3 and 3:1 when measured from the back view.

5. The CPM according to claim 3, wherein
the shape of the core magnet regions M1, M2, or the cladding magnet region Mc12 is in the form of a rectangle, trapezoid, fan, or a custom defined shape from the top view.

6. The CPM according to claim 3, further comprising
additional cladding magnet regions Mc11 and Mc22 adjacent to the core magnet regions M1 and M2, respectively,
and the magnetization direction of the cladding magnet regions Mell and Mc22 and the magnetization direction of the core magnet regions M1 and M2 form an angle between 30 and 150 degrees.

7. The CPM according to claim 1, further comprising
another cladding magnet region Mc11 on the opposite side of the core magnet region M1 with respect to the cladding magnet region Mc12, wherein
the magnetization direction of the cladding magnet region Mell and the magnetization direction of the core magnet region M1 form an angle between 30 and 150 degrees.

8. The CPM according to claim 7, wherein
the magnetization direction of the cladding magnet region Mc11 and the magnetization direction of the core magnet region M1 are substantially perpendicular to each other.

9. The CPM as claimed in claim 8, wherein
the magnetization direction of the cladding magnet region Mc11 and the magnetization direction of the other cladding magnet region Mc12 is substantially antiparallel to each other.

10. A composite permanent magnet (CPM) comprising:
a core magnet region M1, and a cladding magnet region Mc12; wherein
the magnetization direction of the core magnet region M1 and the magnetization direction of the cladding magnet region Mc12 forms an angle between 30 and 150 degrees;
there is glue between the core magnet region M1 and the cladding magnet region Mc12 and the glue region width is 20 μm or less;
the difference of the thickness of the cladding magnet and the core magnet is less than 10 μm or less than 0.1% of the thickness of the core magnet;
the size of the cladding magnet Mc12 is smaller than the size of the core magnet M1;
and the magnet has the magnetic materials energy product (BH)max that is higher than 10MGOe for the core magnet region M1 and/or the cladding magnet region Mc12.

11. The CPM as claimed in claim 10, wherein further comprises
a second core magnet region M2 next to the cladding magnet region Mc12; wherein
the magnetization direction of the core magnet region M2 is substantially in the opposite direction as compared to the magnetization direction of the core magnet region M1.

12. The CPM as described in claim 11 is characterized by:
The magnetization direction of the cladding magnet region (Mc12) being substantially perpendicular to the magnetization direction of the first core magnet region (M1) it is adjacent to.

13. The CPM as described in claim 11 is characterized by:
The magnetization directions of the neighboring first and second core magnet regions M1 and M2 being substantially antiparallel to each other.

14. The CPM as claimed in claim 11, wherein
the width to the height ratio of the core magnet regions M1 and M2 is between 2:1 and 10:1;
the width to the height ratio of the cladding magnet regions Mc12 is between 1:3 and 3:1 when measured from the back view.

15. The CPM as claimed in claim 11, wherein
the shape of the first and second core magnet regions (M1 and M2) and the cladding magnet region (Mc12) can be in the form of a rectangle, trapezoid, fan, or any custom-defined shape from the top view.

16. A method to produce a CPM with high energy product (BH)max larger than 10MGOe comprising:
an additional step:
to reorient and stack multiple magnet blocks with different dimensions together; where the smaller piece is corresponding to the cladding magnet Mc12; and the cladding magnet to have magnetic crystalline anisotropy direction with an angle between 30-150 degrees with respect to the magnetic crystalline anisotropy direction of the larger core magnet piece M1 and/or M2;
before the process step of cutting, machining and grinding;
and before the magnetizing of the CPM.

17. The method for producing CPMs as claimed in claim 16, further comprising the step as claimed in claim 16, which is performed after the magnet block is formed by pressing under a magnetic field, but before the step of isostatic pressing.

18. The method to produce CPM as claimed in claim 16, wherein
the step as claimed in claim 16 is used after sintering and annealing processes;
an optional wire cutting may be used to split core magnet regions and define cladding magnet size and shape before reorientation and stacking;
and a glue or an adhesive is applied between cladding magnet block and core magnet blocks.

19. The method for producing CPMs as claimed in claim 16, further comprising
the cutting, machining and grinding process, which is conducted after
the reorientation and stacking, the sintering and annealing process, or
the sintering and annealing process, the cutting, reorientation, stacking and gluing process,
resulting in the formation of the CPM structure.

20. The method to produce CPM as claimed in claim 16, further comprising:
a two-step magnetizing processes which magnetizing the cladding magnet region Mc12 and the magnetizing core magnet region M1 separately;
the two-step magnetizing processes start after the cutting, machining and grinding process;
and the order of these two step magnetizing may be switched.
